(19) United States
(12) Patent Application Publication
(10) Pub. No.: US 2003/0209863 A1
(43) Pub. Date: Nov. 13, 2003

(54) Self-aligning sealing apparatus providing axial sealing and controlled compression limits

(76) Inventor: Kyle Gregoire, Ontario (CA)

Correspondence Address: RANDALL J. KNUTH P.C., 3510-A STELLHORN ROAD, FORT WAYNE, IN, 46815-4631, US

(21) Appl. No.: 10/392,659

(22) Filed: Mar. 20, 2003

Related U.S. Application Data
(60) Provisional application No. 60/366,308, filed on Mar. 21, 2002.

(51) Int. Cl. F16L 17/06

(52) U.S. Cl. 277/611

(57) ABSTRACT

A sealing apparatus includes an annular seal and a retention ring annularly disposed about and joined to the seal. The retention ring fully supports, retains and carries the seal so that the application environment need not provide any structure to hold the seal, such as a machined groove. The seal is disposed in axial seal engagement with two cylindrical tubes that are registered in fluid communication with one another. A means is provided to limit axial compression of the seal so as to prevent seal extrusion otherwise arising from excessive compression.

### CROSS-REFERENCE TO RELATED APPLICATIONS

This application claims the benefit of U.S. Provisional Application No. 60/366,308 filed Mar. 21, 2002.

### BACKGROUND OF THE INVENTION

1. Field of the Invention

The present invention relates to a sealing apparatus, and, more particularly, to an assembly including a seal carried by a retention ring that includes a mechanism to prevent extrusion by limiting the compression range of the seal.

2. Description of the Related Art

In attempting to seal an opening between two members, such as two tubes, many problems are incurred. Conventional arrangements utilize an O-ring to radially seal an opening between two tubes. The O-ring is pressed into a retaining groove on one of the tubes so that the seal does not move around the tube's outer diameter. Extra machining of the tube is necessary to create the retaining groove in the tube. The extra machining of the tube, however, introduces additional costs into the systems.

Additionally, the O-ring seals the opening between the two tubes radially. The problem with radial sealing of the opening between two tubes is that a small movement of either tube, such as one of the tubes shrinking, releases the sealing engagement with the tube and the seal, therefore allowing fluid to flow past the seal through the opening between the two tubes. Furthermore, O-rings wear quickly and need to be replaced often. The replacement of the O-rings can likewise be expensive.

Another problem with sealing two members, such as tubes, is that the seal may get extruded due to excessive compression between the two tubes. If the seal is extruded, the seal would become released from its sealing engagement with the tube and therefore allow fluid to flow past the seal and through the opening between the two tubes.

The present invention addresses and overcomes these problems.

### SUMMARY OF THE INVENTION

According to the present invention, there is provided a sealing apparatus including an annular seal and a retention ring annularly disposed about and joined to the seal. The retention ring fully supports, retains and carries the seal so that the application environment need not provide any structure to hold the seal. In particular, by virtue of the retention ring, the seal is fully housed and retained independently of any registration features provided in the tubular fluid communicating components, such as a machined groove evident in conventional arrangements.

The seal is disposed in axial seal engagement with the cylindrical tubes in the form of a face seal, for example. A means is provided to limit axial compression of the seal so as to prevent seal extrusion otherwise arising from excessive compression. In particular, in one form, the compression limiter is configured such that end surfaces of the cylindrical tubes will abut the compression limiter and be prevented from advancing further in the axial direction, thereby stopping any further axial compression of the seal.

In one form, the axial compression limiter is provided as an annular shoulder or flange extending radially inwardly from the inner diametrical surface the retention ring. The annular shoulder would be disposed annularly between the retention ring and the seal. The seal is joined to the annular shoulder and may include a portion that extends radially along the annular shoulder and attach to the retention ring.

One advantage of the present invention is that the use of a retention ring to carry and fully contain the seal enables the seal assembly to function as a self-aligning and self-supporting mechanism capable of positioning the seal in its sealing location without the provision of registration features in the host or application environment, such as retaining grooves machined in a tube surface.

Another advantage of the invention is that the use of a retention ring to fully capture and house the seal in a unitized, modular construction facilitates automatic placement and registration of the seal in its proper sealing location immediately upon installation of the retention ring-seal package in the host or application environment.

Another advantage of the present invention is that the seal assembly effectively provides a press-in-place gasket that allows the seal to be configured in locations that otherwise cannot be accessed with conventional sealing techniques that require the use of a machined groove to hold the seal.

A further advantage of the invention is that one form of the seal assembly provides axial sealing engagement, as compared to the radial sealing typically found in conventional arrangements.

Another advantage is that the axial sealing engagement employed by the invention avoids the stricter tolerance specifications attending the use of a radial seal, where the design of the O-ring radial seals must be tailored to the strict guidelines regarding maintenance of the tight clearance space between concentric tubes, for example. Due to the axial sealing engagement, the invention provides more versatility and freedom in the overall construction of the joint environment, namely, the ability to accept and seal tubular members with larger tolerance bands vis-à-vis the fitting geometries.

Another advantage of the invention is that the seal assembly incorporates a mechanism to define a limit on the axial compression of the seal, thereby preventing over-compression of the seal and avoiding the possibility of seal extrusion that typically follows as a consequence of excessive compression.

Another advantage of the invention is that manifold improvements in design and functionality are offered in one exemplary form that integrates a retention ring, an elastomeric seal captured and fully supported by the retention ring, and a means to limit compression of the seal.

Another advantage of the invention is that the means to limit compression of the captured seal may be embodied in forms that involve structures forming part of the retention ring itself, thereby adapting the ring to provide the compression limiting feature in a one-piece construction.

Another advantage of the invention is that the means to limit compression of the captured seal may be provided as a distinct piece that forms a compound structure with the retention ring, thereby allowing the overall design to exhibit a selectable compression range depending upon the specific embodiment of the compression limiting means that is installed in the assembly.

Another advantage of the invention is that the entire seal assembly is symmetrical about its central axis, so that the assembly need not be installed according to a specific orientation; for example, the seal has identical geometry and functionality regardless of its vertical or horizontal orientation (e.g., an inverted (upside-down) or axially reversed (backwards) installation are the same).

Another advantage of the invention is that the compression limiting means provides control and regulation of the amount of compression applied to the seal, a distinct improvement over conventional designs.

Another advantage of the invention is that the seal and retention ring arrangement can be adapted to be joined to one of the components to be sealed (e.g., tube) prior to field installation, thereby forming a subassembly that can be readily integrated with the other component to form a final installed unit.

Another advantage of the present invention is that no retaining groove is necessary to keep the seal in proper position on the tube. Eliminating the retaining groove eliminates extra machining of the tube, which results in cost savings otherwise expended on the supplemental machining.

Another advantage of the present invention is that the opening between the two tubes is sealed axially, such as with the use of a face seal. Sealing the opening between the two tubes axially allows for more movement of the tubes than a conventional radial-type O-ring would allow, all without losing sealing engagement between the two tubes.

Yet another advantage of the present invention is that the compression between two tubes is controlled or otherwise limited to minimize and/or eliminate the possibility of seal extrusion. If the seal is extruded, fluid will be allowed to flow past the seal through the opening between the two tubes. Also, the seal will wear slower than the conventional O-ring because of the limited compression on the seal.

Yet another advantage of the present invention is that the components of the present invention are reversible and therefore the invention cannot be assembled incorrectly.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1A is an axial cross-sectional planar view of a sealing assembly in a relaxed non-compression state, according to one form of the invention;

FIG. 1B is a radial cross-sectional planar view of the sealing assembly shown in FIG. 1A;

FIG. 1C is a view similar to FIG. 1A illustrating the configuration of the sealing assembly in a compression condition;

FIG. 2A is an axial cross-sectional planar view of a sealing assembly in a relaxed non-compression state, according to another form of the invention;

FIG. 2B is a radial cross-sectional planar view of the sealing assembly shown in FIG. 2A;

FIG. 2C is a view similar to FIG. 2A illustrating the configuration of the sealing assembly in an intermediate compression condition;

FIG. 2D is a view similar to FIG. 2A illustrating the configuration of the sealing assembly in a full compression condition;

FIGS. 3A-3F depict a series of fragmentary axial cross-sectional views of various constructions of an axial compression limiter, according to other forms of the invention;

FIGS. 4A and 4B are axial cross-sectional views of a sealing assembly according to the invention, installed in one illustrative application environment;

FIGS. 5A and 5B are axial cross-sectional views of a sealing assembly according to the invention, installed in another illustrative application environment;

FIGS. 6A and 6B are axial cross-sectional views of a sealing assembly according to the invention, installed in another illustrative application environment;

FIGS. 7A and 7B are axial cross-sectional views of a sealing assembly according to the invention, installed in another illustrative application environment;

FIGS. 8A and 8B are axial cross-sectional views of a sealing assembly according to a different embodiment;

FIGS. 9A and 9B are axial cross-sectional views of a sealing assembly according to another different embodiment;

FIGS. 10A and 10B are axial cross-sectional views of a sealing assembly according to another different embodiment;

FIGS. 11A and 11B are axial cross-sectional views of a sealing assembly according to another different embodiment;

FIG. 12 is an axial cross-sectional view of a sealing device, according to another form of the invention;

FIG. 13 is an axial end view of the sealing device shown in FIG. 12;

FIG. 14 is an axial cross-sectional view of the sealing device of FIG. 12, as installed in an illustrative application environment; and

FIGS. 15A and 15B are axial cross-sectional views of conventional sealing arrangements.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

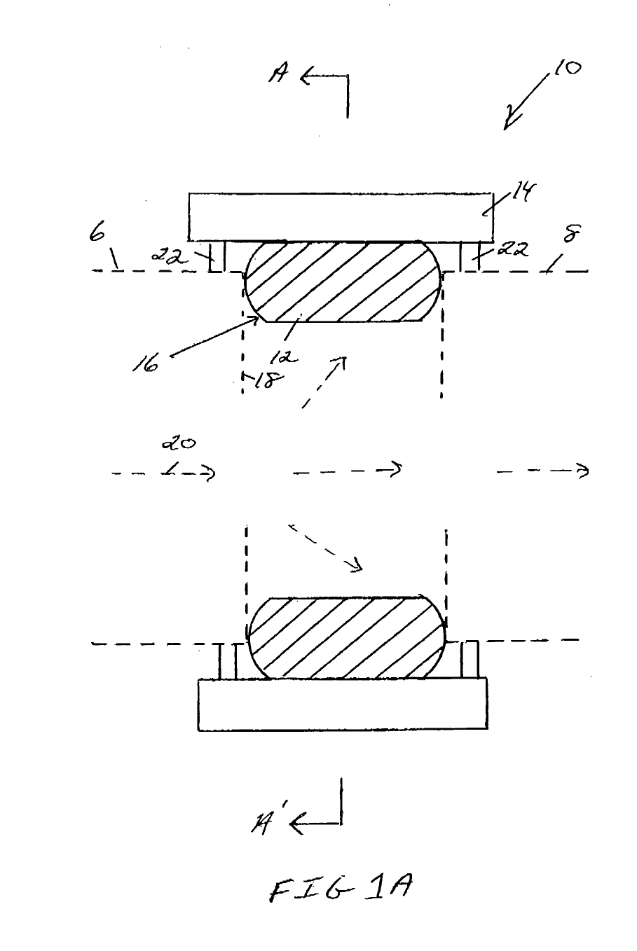

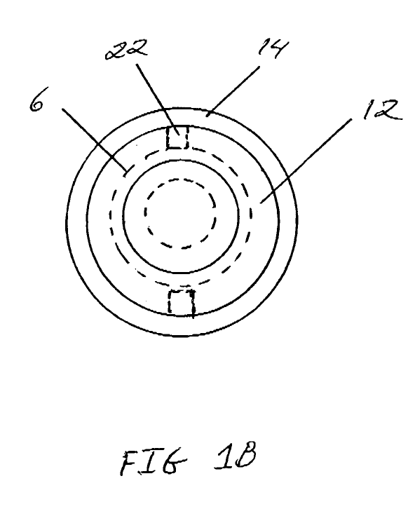

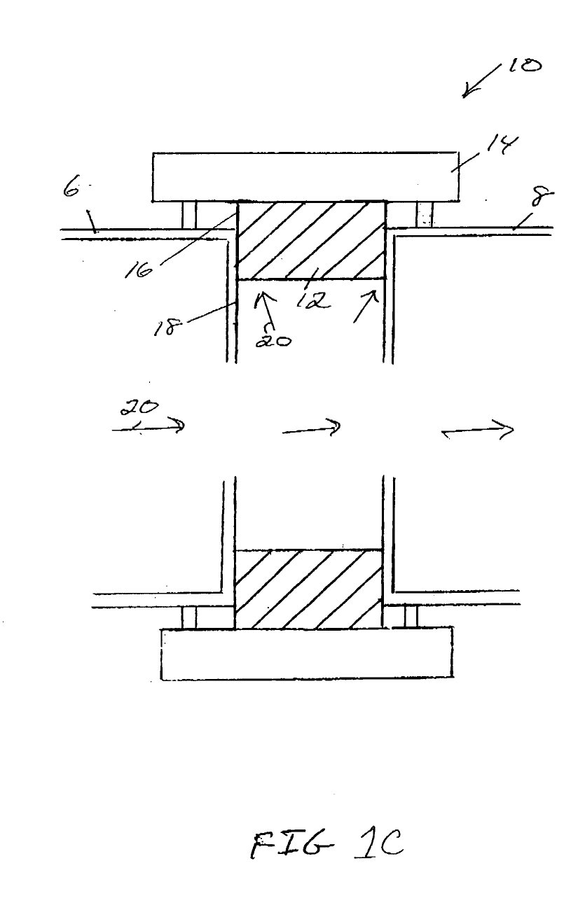

Referring now to the drawings and particularly to FIG. 1A, there is shown an axial cross-sectional planar view of a sealing assembly 10 in a relaxed non-deforming state, according to one form of the invention. FIG. 1B is a radial cross-sectional planar view of assembly 10 taken along lines A-A′ of FIG. 1A. FIG. 1C illustrates in a view similar to FIG. 1A the configuration of assembly 10 in an operational state, namely, in response to axial compression.

The illustrated assembly 10 includes a seal 12 and retention device 14. In one aspect of the invention, seal 12 is provided in the form of an annular seal member. Seal 12 may be fabricated from any of various materials, including, but not limited to, elastomer and other structures suitable for sealing purposes known to those skilled in the art, such as deformable, elastic, and/or compressible materials.

Retention device 14 may be provided in the form of a retention ring or other suitable housing structure to contain, capture, house, support, and otherwise carry seal 12 to form a modular, integrated unit. For this purpose, any suitable means may be used to join seal 12 to retention ring 14. In the form shown by FIG. 1A, seal 12 is disposed radially inwardly of ring 14, so that the outer radial surface of seal 12 is joined to the inner radial surface of ring 14.

FIG. 1A further indicates in phantom the relationship of sealing assembly 10 to exemplary components 6 and 8 for which assembly 10 is intended to provide a sealing activity therebetween. Components 6 and 8 may include, but are not limited to, cylindrical structures and tubular constructions that are joined together to facilitate a fluid flow therebetween. It is at the joint between components 6 and 8 where sealing assembly 10 is located to provide sealing. An exemplary fluid stream is indicated by illustrative fluid lines 20 to illustrate typical fluid communication between components 6 and 8.

In one feature, seal 12 is provided at both axial ends thereof with a convex portion 16 to facilitate a firmer pressing engagement of seal 12 against the opposing end surfaces 18 of the respective components 6 and 8 once component 6 and/or component 8 is displaced toward one another to cause axial compression of seal 12, as shown in FIG. 1C. Under compression, the convex portion 16 will generate a highly directed sealing pressure against the opposing surface 18 to provide a tightly sealed interface preventing the advance of fluid beyond the interior environment of the joint.

The specific forms and geometries of seal 12 and ring 14 in the figures should not be considered in limitation of the invention but merely illustrative, as it should be apparent that other constructions are possible within the scope of the invention.

According to another aspect of the invention, assembly 10 is provided with a mechanism depicted illustratively at 22 that is employed to attach assembly 10 to one or both of components 6 and 8. In one form, for example, an arrangement of crush ribs may be used to implement this attachment mechanism, although it should be apparent that any other suitable structure may be used to provide a similar functionality.

Several advantages are manifested by the design and configuration of assembly 10. For example, it is seen in conventional arrangements that the sealing element is positioned within a groove or channel machined into the surface of one of the components in order to accommodate and otherwise receive the seal. However, in the invention, seal 12 is carried, retained, and otherwise supported solely by retention ring 14, thereby obviating the need for any seal-receiving channels in either of the components. Accordingly, with the invention, the host or application environment is relieved of any responsibility to provide a structure for holding and securing the seal, as in conventional sealing arrangements.

Additionally, the installation of assembly 10 typically involves positioning of ring 14 relative to components 6 and/or 8, such as with the use of attachment mechanism 22. Accordingly, once assembly 10 is installed, no further reconfiguration of seal 12 is needed since the placement of ring 14 automatically positions seal 12 in its sealing location relative to components 6 and 8. Thus, since seal 12 is part of a modular package, assembly 10 effectively provides self-alignment and self-registration of the sealing element simply as a consequence of assembly 10 being installed in the host environment.

Referring now to FIG. 1C, there is shown an exemplary configuration of sealing assembly 10 during an operational state, namely, when seal 12 experiences axial compression due to the axial displacement of component 6 and/or component 8. As shown, in response to displacement of component 6 and 8 toward one another in the operational configuration, the exemplary axial end surface 18 of component 6 is forced against and thereby induces axial compression of seal 12 so that the opposing axial end surface 16 of seal 12 enters into a flush surface-to-surface axial sealing engagement with component 6 to form a fluid-tight interface. The radial extent of such axial sealing engagement may be selected by suitable design and placement of seal 12 relative to the sealing surfaces of the components.

As a result, the axial sealing engagement between seal 12 and each of components 6 and 8 prevents fluid 20 from flowing radially further than seal 12 and into the exterior environment. Notably, in the form depicted by FIG. 1, the invention provides an axial sealing activity between the components, as distinguished from conventional arrangements that rely solely on a radial sealing action, e.g., the seal is formed between opposing radial surfaces of the seal and the tube.

Additionally, in the form shown in FIG. 1, sealing assembly 10 can accommodate certain axial movements or flexing of components 6 and 8 without compromising the integrity of the seal, provided that seal 12 remains sufficiently compressed so that the sealing interface or joint between seal 12 and the components remains sufficiently intact and does not release. However, with conventional radial seals, axial flexing of the tubes can produce a shearing action on the seal that can impair its integrity.

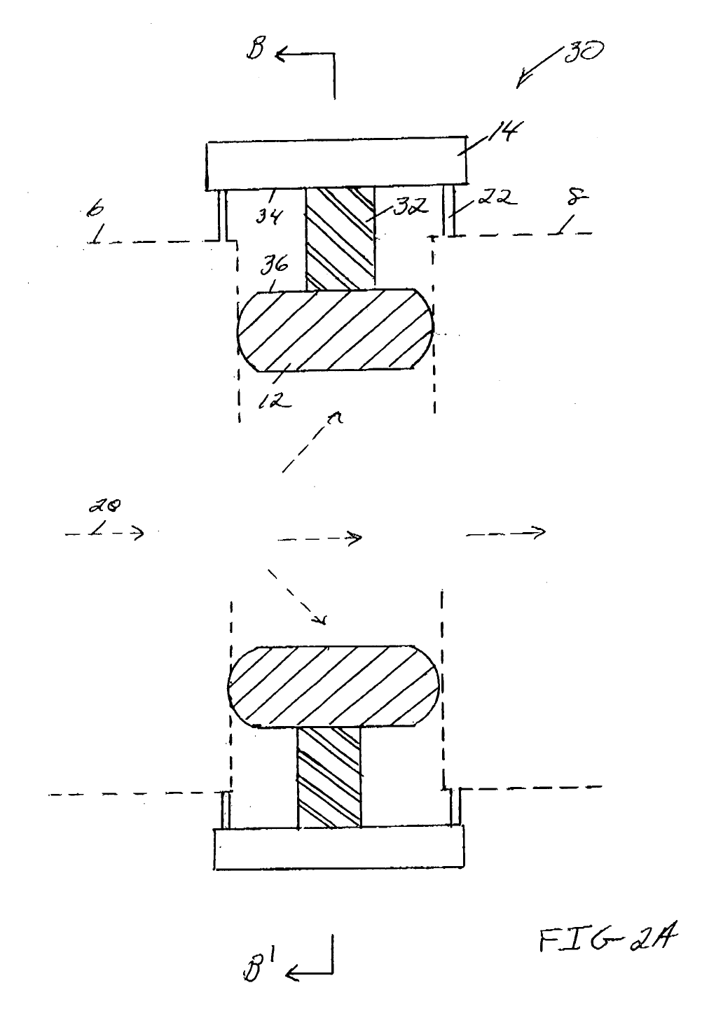

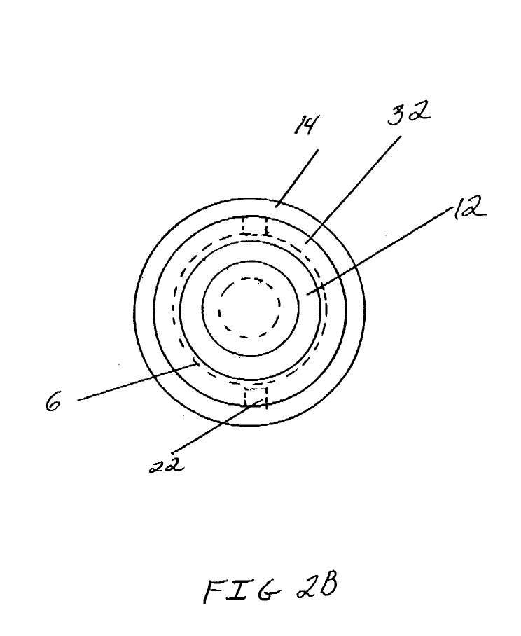

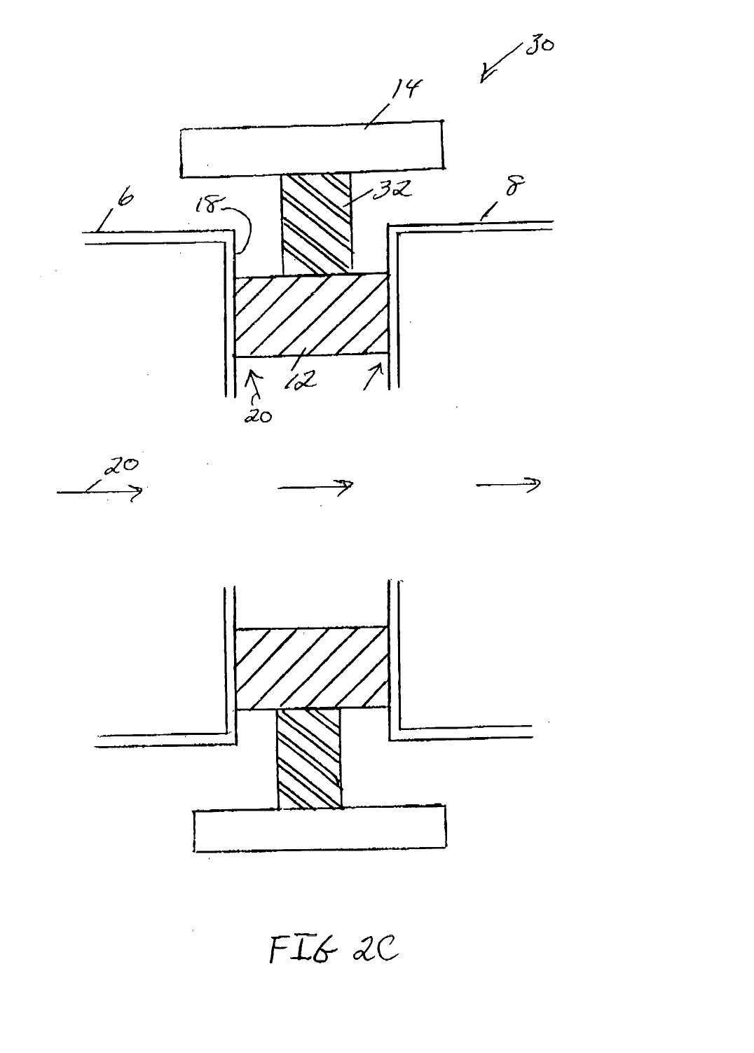

Referring now to FIG. 2A, there is shown an axial cross-sectional planar view of a sealing assembly 30 in a relaxed non-deforming state, according to another form of the invention. FIG. 2B is a radial cross-sectional planar view of assembly 30 taken along lines B-B′ of FIG. 2A. FIGS. 2C and 2D illustrate in a view similar to FIG. 2A the configuration of assembly 30 in an intermediate and full axial compression state, respectively.

The illustrated sealing assembly 30 is similar to sealing assembly 10 depicted in FIG. 1, but incorporates a means to define a limit on the amount of axial compression that the sealing element can experience. This compression limiter effectively controls the maximum amount of allowable axial compression to which the seal may be subject. One purpose of such a means is to ensure that the seal does not experience excessive compression that might lead to seal extrusion, as typically occurs in conventional arrangements where no mechanism is featured that inhibits the type of compression that could precipitate extrusion, tearing, or other permanent or irreversible damage or deformation to the seal.

Sealing assembly 30 similarly includes seal 12 and retention ring 14, but also incorporates a stop device or compression limiter 32 that acts to define a limit on the amount of axial compression of seal 12, preferably in both axial directions. In various forms, compression limiter 32 may implement a “hard” or “soft” stop on axial compression. For example, a hard-stop will prevent any further axial compression of the seal (e.g., the limiter is constructed of relatively incompressible material for the expected application scenarios). By comparison, a soft-stop would oppose and otherwise provide increased resistance to further axial compression of the seal, but could allow further displacement of the seal if the compressing force was sufficient. For example, in one form, a soft-stop limiter could be constructed of a material composition having a rigidity greater than the seal (e.g., lower compressibility), so that the compression resistance of the limiter would have to be overcome to cause further compression of the seal.

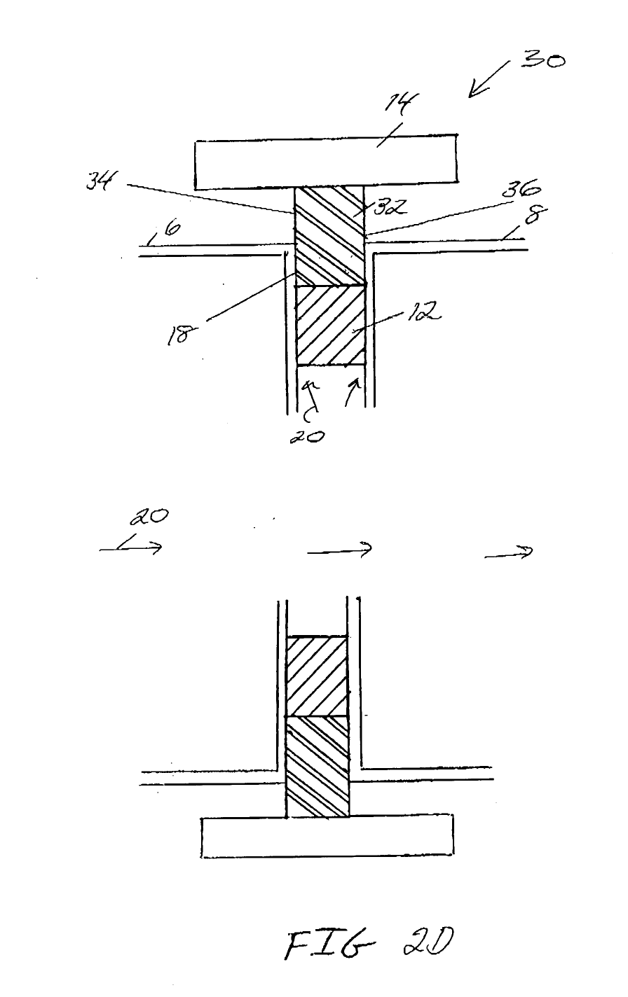

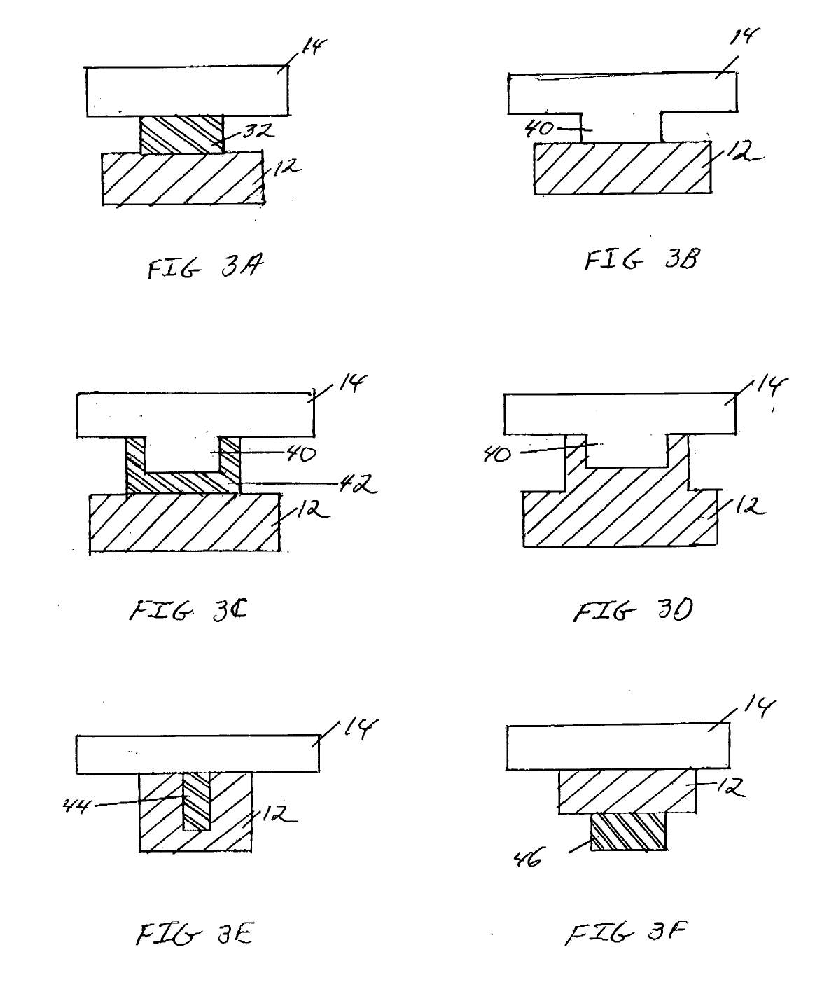

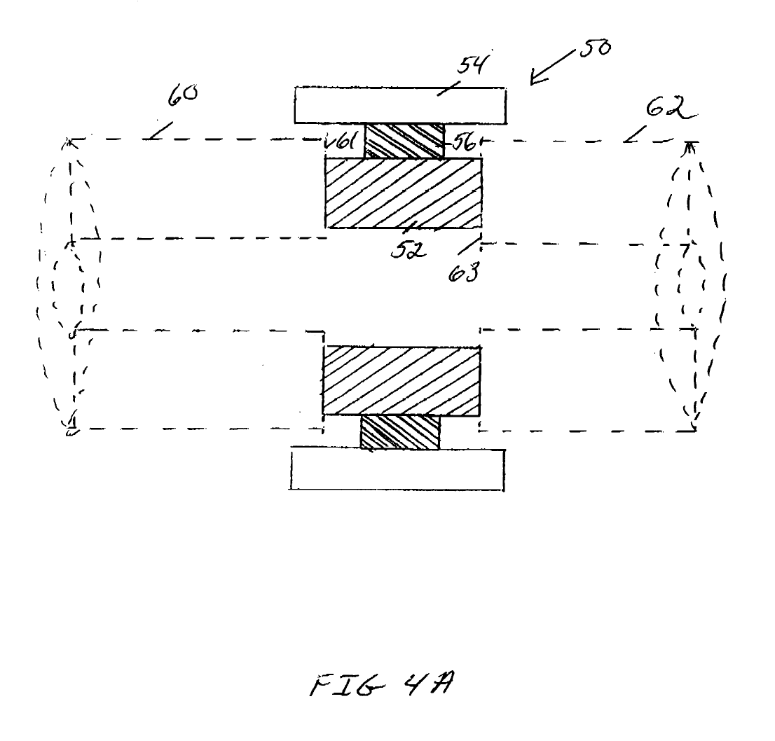

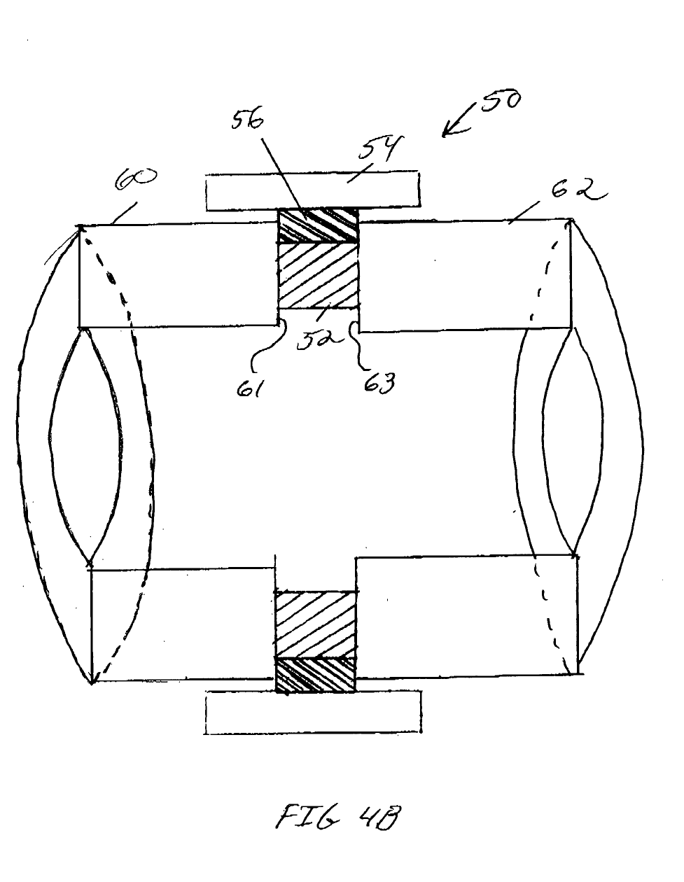

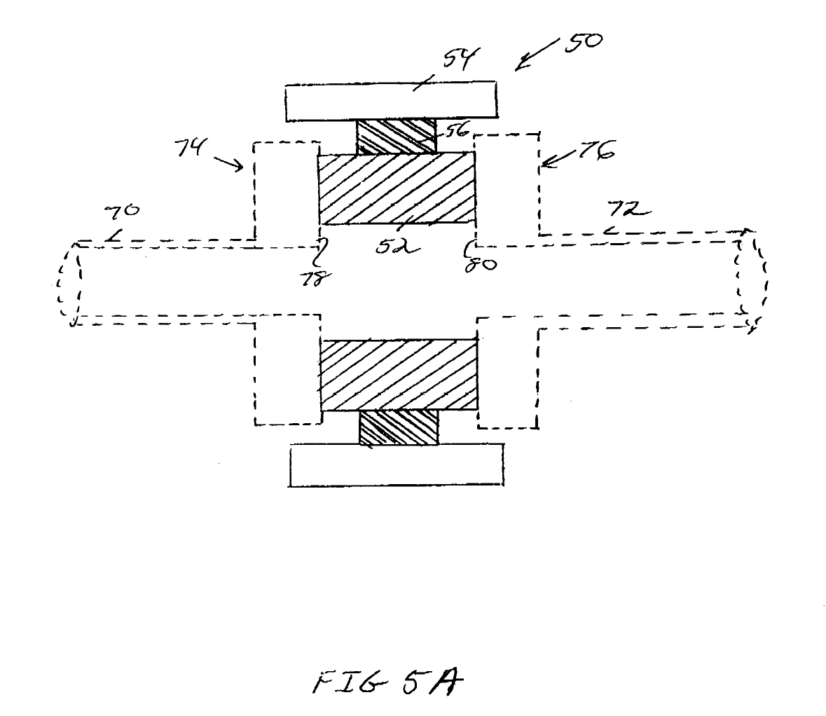

As shown, the illustrated compression limiter 32 is disposed annularly between seal 12 and ring 14. In combination, these components form a modular package that is installed as a unit in the application or host environment. It should be understood that the form and structure of limiter 32 is illustrative and should not be considered in limitation of the invention, as the illustrated compression limiter 32 is generally representative of any means capable of defining a limit on the axial compression of seal 12. As discussed further, FIG. 3 shows various alternate forms for implementing compression limiter 32, although other forms are possible within the scope of the invention.

As shown, compression limiter 32 has a continuous annular shape, although it is possible for limiter 32 to be provided as a segmented configuration including an arrangement of individual stop blocks disposed annularly about an inner periphery of ring 14. Limiter 32 is joined to ring 14 at an inner radial surface 34 of ring 14. Limiter 32 is joined to seal 12 at an outer radial surface 36 of seal 12. However, despite the incorporation of limiter 32, it is clear that assembly 30 retains the same advantages as sealing assembly 10 in FIG. 1. In particular, seal 12 continues to be carried and otherwise supported by ring 14 so that the application environment still need not supply any registration features (e.g., grooves) for seal 12.

Referring now to FIG. 2C, there is shown an operational use of sealing assembly 30 during an illustrative intermediate compression condition, namely, a level of axial compression between a fully relaxed state (no applied compressing force) and the maximum allowable compression level (as determined by limiter 32). The operational features of seal 12 relative to its sealing interaction with components 6 and 8 are similar to those discussed in relation to FIG. 1. In particular, the manner in which seal 12 of FIG. 2 cooperates with and forms an axial sealing engagement with components 6 and 8 is similar to that in FIG. 1.

Referring now to FIG. 2D, there is shown an operational use of sealing assembly 30 during an illustrative maximum allowable compression condition for seal 12, as determined by limiter 32. In all other respects, the operational features of seal 12 relative to its sealing interaction with components 6 and 8 are similar to those discussed in relation to FIG. 1.

As shown, on both axial sides of seal 12, axial compression of seal 12 is stopped at the respective axial locations where component 6 (at surface 18) abuts first axial-facing surface 34 of limiter 32 and component 8 abuts second axial-facing surface 36 of limiter 32. The dimensions of limiter 32 are chosen (especially the axial extent) such that the maximum allowable axial compression of seal 12 meets certain specified criteria, for example, such as elastic return thresholds and extrusion avoidance. It is apparent that limiter 32 may act to stop axial compression concurrently in both directions or in only one direction.

Beyond its chief functionality involving control of the amount of axial compression of seal 12, compression limiter 32 also incidentally assists seal 12 in the sealing activity because it effectively extends the seal line provided by seal 12. In particular, a seal may also be formed by the axial engagement between surfaces 34 and 36 of limiter 32 and the opposing surfaces of components 6 and 8. For this purpose, limiter 32 may be formed of materials and have a construction that fosters and otherwise facilitates such a contribution to the sealing properties of assembly 30.

Referring now to FIG. 3, there is shown a series of fragmentary axial cross-sectional views of various implementations of the compression limiting means illustrated by limiter 32 of FIG. 2, according to other forms of the invention.

Referring to FIG. 3A, the configuration shown is similar to that described in connection with FIG. 2. In one form, it is considered that compression limiter 32 is a discrete device distinct from seal 12 and retention ring 14, but joined to both parts in any conventional manner known to those skilled in the art.

Referring to FIG. 3B, the compression limiting means is provided in the form of an annular shoulder or flange piece 40 extending from the inner radial surface of retention ring 14 and joined to seal 12. In one aspect, shoulder 40 is constituted and otherwise formed as a part of retention ring 14.

Referring to FIG. 3C, the compression limiting means is provided in the form of annular shoulder 40 similar to FIG. 3B, but modified to further include an annular outer element 42 (joined to seal 12) extending axially and radially along the surfaces of shoulder 40. The combination of shoulder 40 and outer element 42 may be adapted to provide a soft-stop and hard-stop, respectively, in relation to axial compression of seal 12.

For example, during the axial compression of seal 12, the end surfaces of the components in engagement with seal 12 (not shown) would first encounter outer element 42. If element 42 is made of an elastomer material, it will accommodate further axial compression of seal 12, but only until element 42 reaches a compression point where rigid shoulder 40 beings to exert a firm resistance to further compression.

In one exemplary form, it may be considered that outer element 42 has a generally U-shaped cross-section, as shown.

Referring to FIG. 3D, the compression limiting means is similar to that shown in FIG. 3C, but modified so that outer element 42 from FIG. 3C is now formed as a constituent part of seal 12 as a one-piece unitized construction.

Referring to FIG. 3E, the compression limiting means is provided in the form of an annular piece 44 similar to compression limiter 32 of FIG. 3A. However, as shown, seal 12 fully envelops piece 44, or at least partially extends radially along annular piece 44.

Referring to FIG. 3F, the compression limiting means is provided in the form of an annular piece 46 disposed inwardly of seal 12. In this form, as shown, seal 12 is disposed annularly between retention ring 14 and piece 46. In all other respects, however, annular piece 46 functions similarly to compression limiter 32 of FIG. 3A.

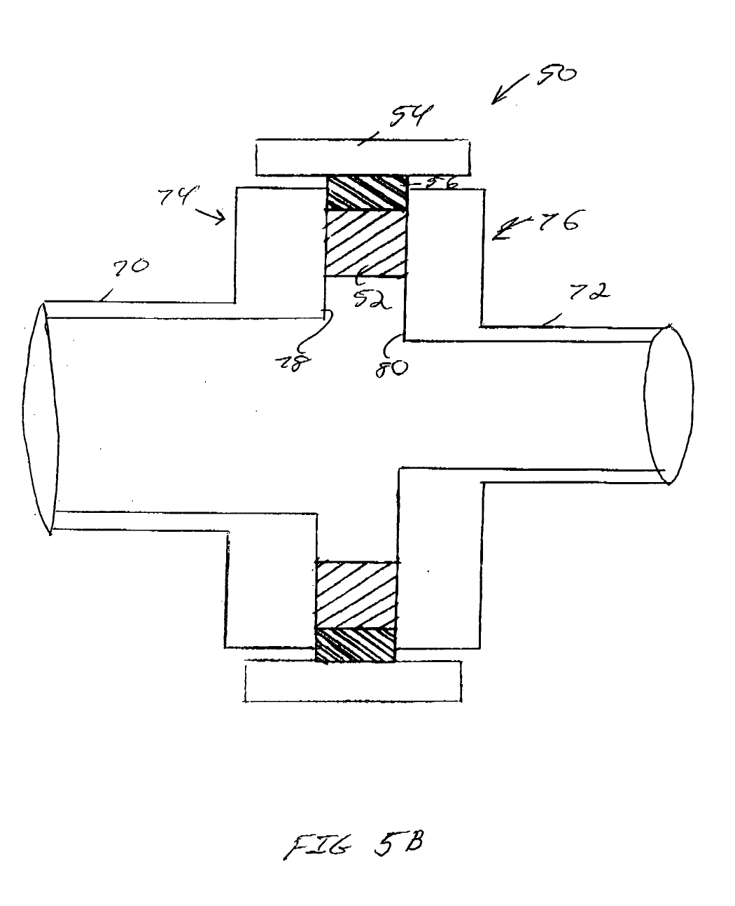

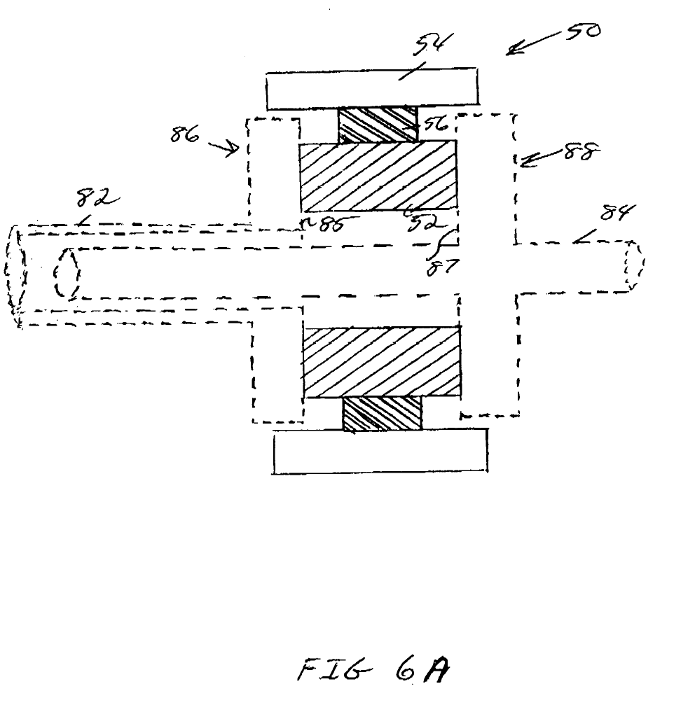

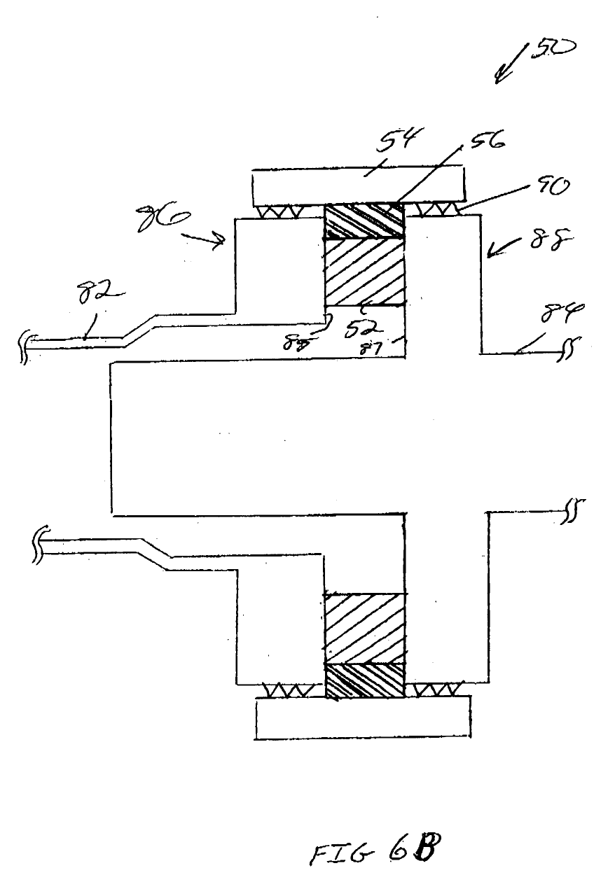

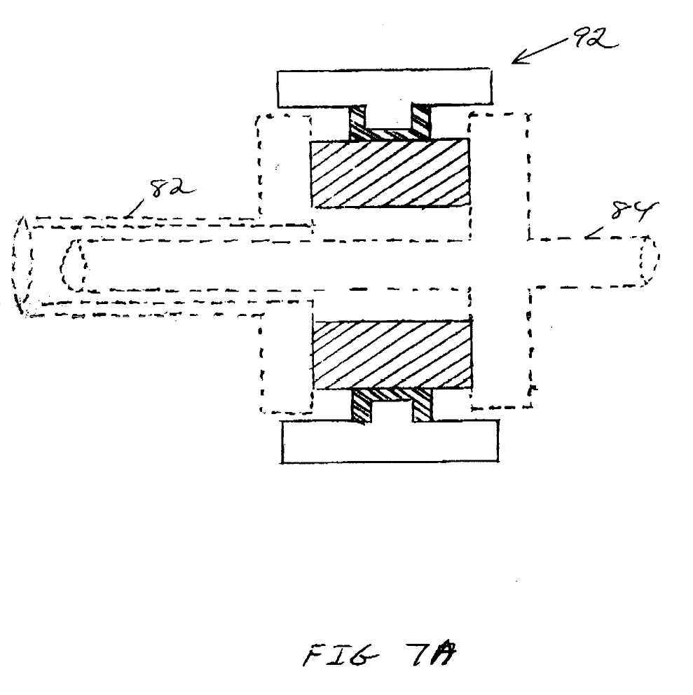

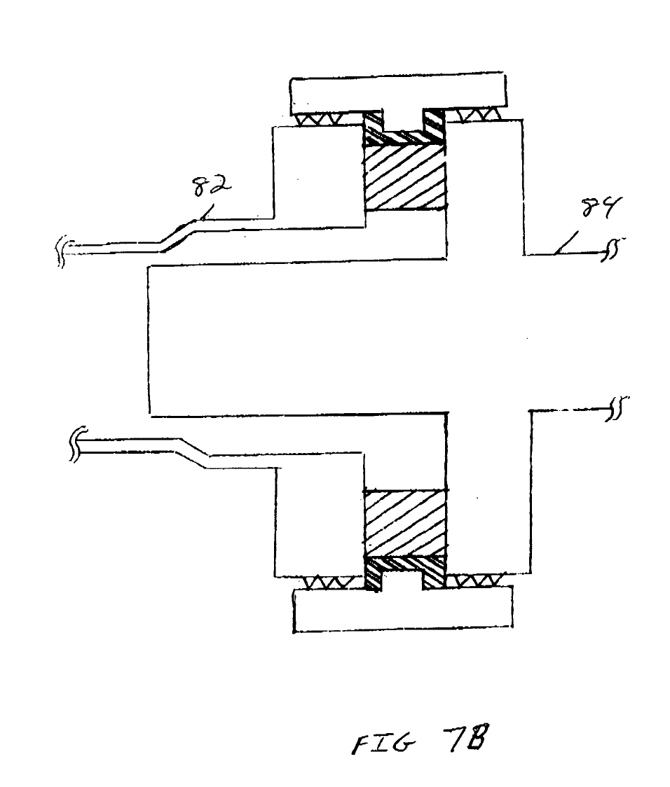

Referring now to FIGS. 4-7, there are shown axial cross-sectional views of several sealing assemblies installed in various application environments to illustrate various ways of practicing the invention. In particular, FIG. 4 shows an end-to-end coupling of tubes (i.e., non-overlapping), where the axial sealing engagement is made with respect to end faces of the tubes. FIG. 5 likewise shows an end-to-end coupling of tubes, but the axial sealing engagement is made with respect to the end faces of annular flanges extending radially from the outer surface of the tubes. FIG. 6 shows a telescoping arrangement between the tubes.

Referring now to FIG. 4A, there is shown a configuration of sealing assembly 50 in a relaxed state, while FIG. 4B shows a configuration of sealing assembly 50 in a compressed state. Sealing assembly 50 is similar to sealing assembly 30 of FIG. 2 in terms of construction and functionality. Accordingly, sealing assembly 50 includes seal 52, retention ring 54, and compression limiter 56 similar to components 12, 14, and 32 of sealing assembly 30, respectively. The depiction of the application environment in connection with sealing assembly 50 is merely illustrative, as any form of the invention could be practiced in the application environment.

As shown, the application environment includes a first cylinder 60 coupled to second cylinder 62 in opposing end-to-end relationship, with sealing assembly 50 serving as the sealing joint therebetween in a manner similar to that discussed previously. In this form, the axial sealing engagement between seal 52 and the respective cylinders 60 and 62 is formed with the axial end faces 61 and 63 of cylinders 60 and 62, respectively.

Referring now to FIG. 5A, there is shown a configuration of sealing assembly 50 in a relaxed state, while FIG. 5B shows a configuration of sealing assembly 50 in a compressed state.

As shown, the application environment includes a first cylinder 70 coupled to second cylinder 72 in opposing end-to-end relationship, with sealing assembly 50 serving as the sealing joint therebetween in a manner similar to that discussed previously. First and second cylinders 70 and 72 include flanges 78 and 80, respectively, that extend radially from an outer surface thereof. In this form, the axial sealing engagement between seal 52 and the respective cylinders 70 and 72 is formed with the axial end faces 78 and 80 of cylinder flanges 74 and 76, respectively.

Referring now to FIG. 6A, there is shown a configuration of sealing assembly 50 in a relaxed state, while FIG. 6B shows a configuration of sealing assembly 50 in a compressed state.

As shown, the application environment includes a first cylinder 82 coupled to second cylinder 84 in telescoping relationship, with sealing assembly 50 serving as the sealing joint therebetween in a manner similar to that discussed previously. First and second cylinders 82 and 84 include flanges 86 and 88, respectively, that extend radially from an outer surface thereof. In this form, the axial sealing engagement between seal 52 and the respective cylinders 82 and 84 is formed with the axial end faces 85 and 87 of cylinder flanges 86 and 88, respectively.

FIG. 6B is further shown with illustrative crush ribs 90 for use in attaching sealing assembly 50 (via retention ring 54) to one or both of cylinders 82 and 84.

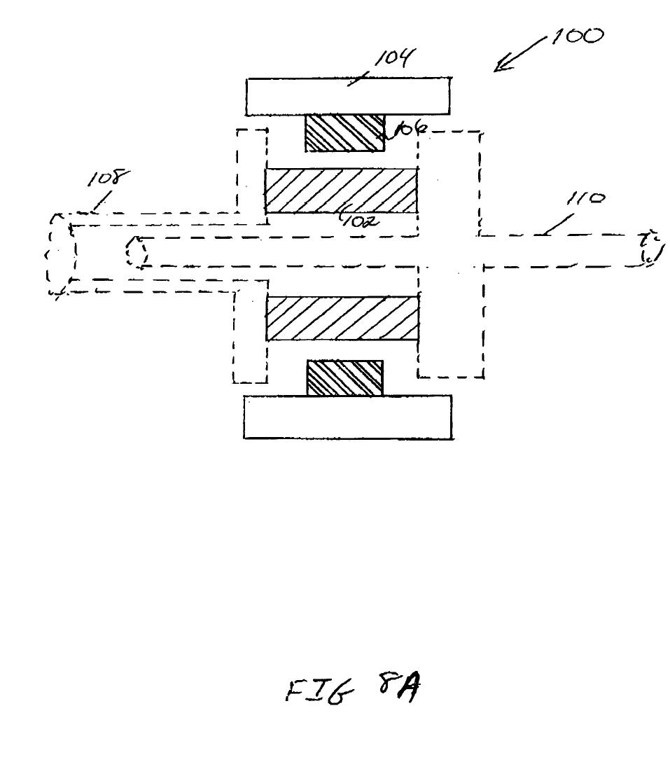

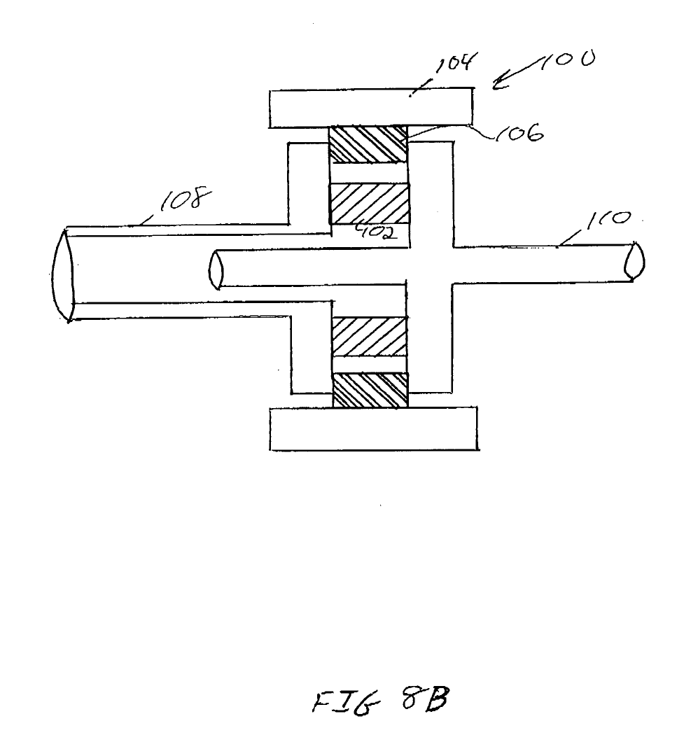

Referring now to FIG. 7A, there is shown a configuration of a sealing assembly 92 in a relaxed state, while FIG. 7B shows a configuration of sealing assembly 92 in a compressed state. Sealing assembly 92 is constructed in accordance with the form of the invention depicted in FIG. 3C. FIGS. 7A and 7B depict a telescoping-type application environment similar to the one described in FIGS. 6A and 6B.

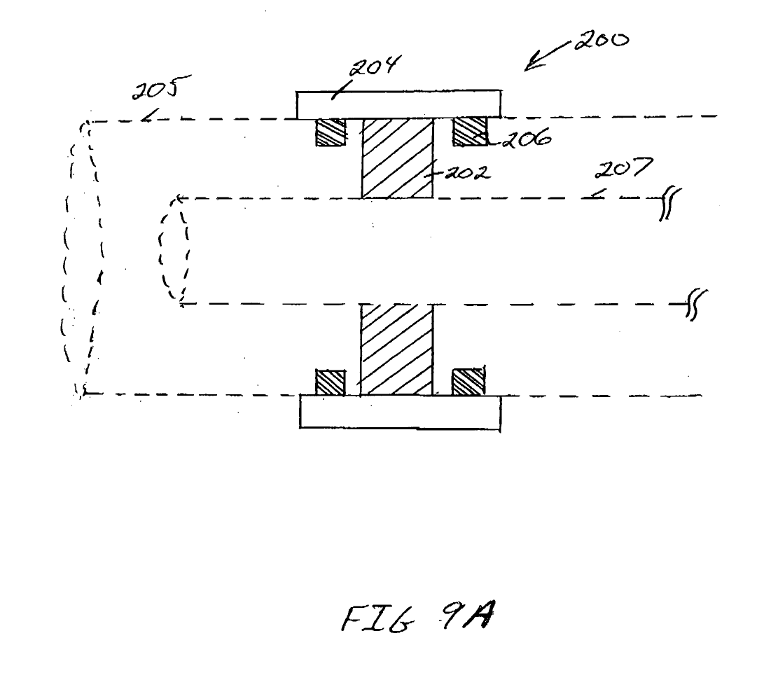

Referring now to FIG. 8A, there is shown a configuration of a sealing assembly 100 in a relaxed state, while FIG. 8B shows a configuration of sealing assembly 100 in a compressed state, according to a different sealing apparatus design. Sealing assembly 100 includes seal 102, retention ring 104, and compression limiter 106 that function similarly to components 12, 14, and 32 of sealing assembly 30, respectively, of FIG. 2. However, in this form, seal 102 is not carried by ring 104. For this purpose, suitable means known to those skilled in the art are provided to dispose seal between illustrative components 108 and 110 in proper sealing position and location. The depiction of the telescoping-type application environment is merely illustrative, as the assembly could be practiced in any other application environment.

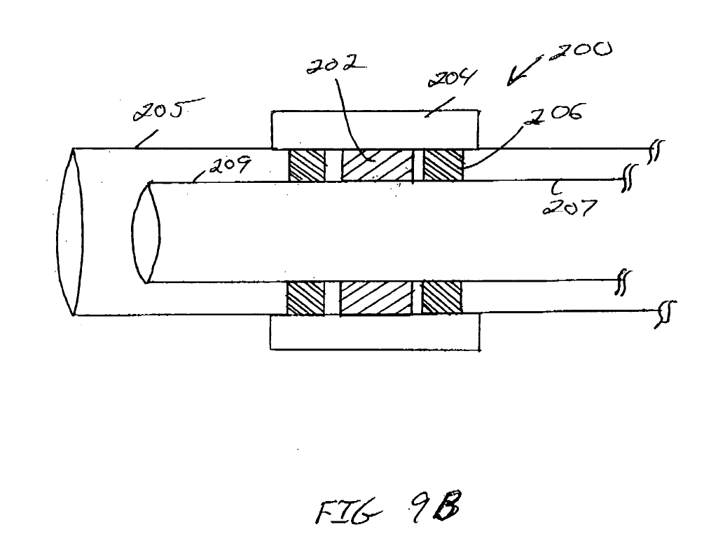

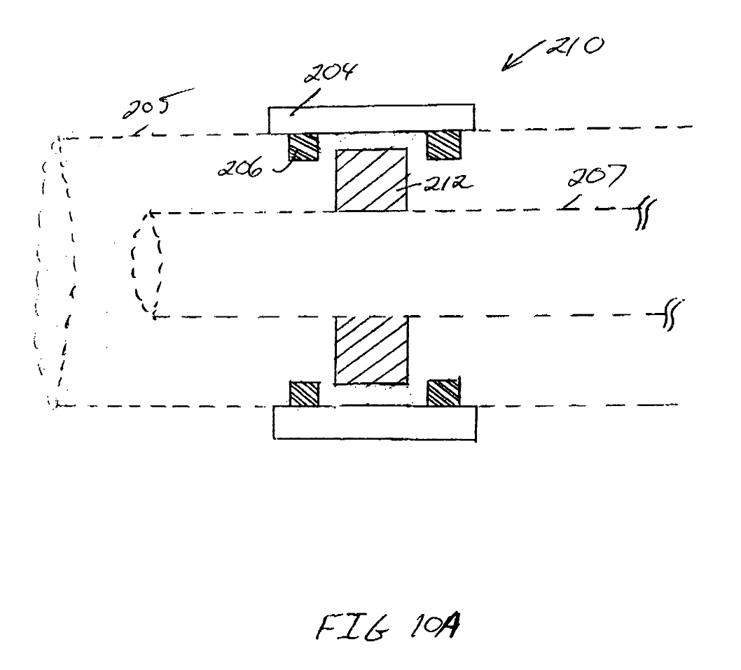

Referring now to FIGS. 9-11, there are shown different forms of a sealing apparatus providing radial sealing, according to a different sealing arrangement.

Referring to FIG. 9A, there is shown a configuration of a sealing assembly 200 in a relaxed state, while FIG. 9B shows a configuration of sealing assembly 200 in a compressed state, according to one design form.

The illustrated sealing assembly 200 includes an annular retention ring 204, an annular seal 202 fully supported and carried by ring 204, and means 206 to limit radial compression of seal 202. Sealing assembly 200 provides radial sealing between components 205 and 207 (shown in phantom). Such means 206 may be fitted into receiving holes formed in the outer surface of cylinder 205, for example, to locate the unit in the application environment.

Referring to FIG. 9B, as seal 202 compresses radially, it is seen that the outer diametrical surface 209 of inner cylinder 207 abuts against the inner radial surface of compression limiting means 206. As before with the axial compression limiter 32 in FIG. 2, radial compression limiting means 206 may be formed to provide a soft-stop or hard-stop in regard to further radial compression of seal 202 once cylinder 207 encounters means 206.

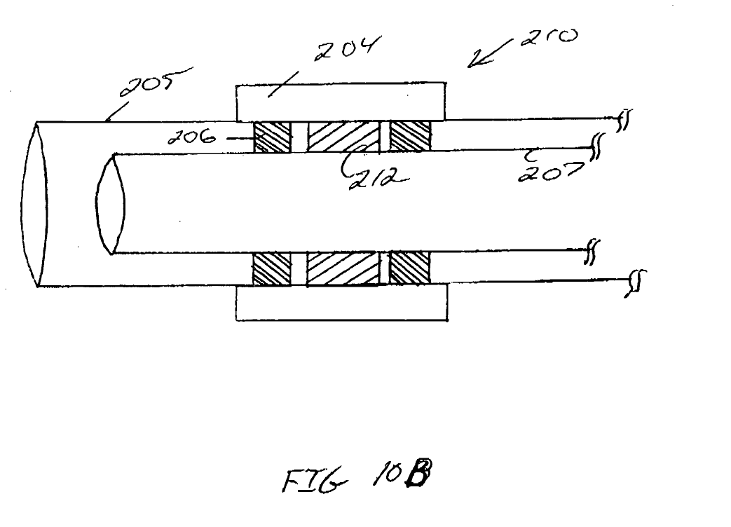

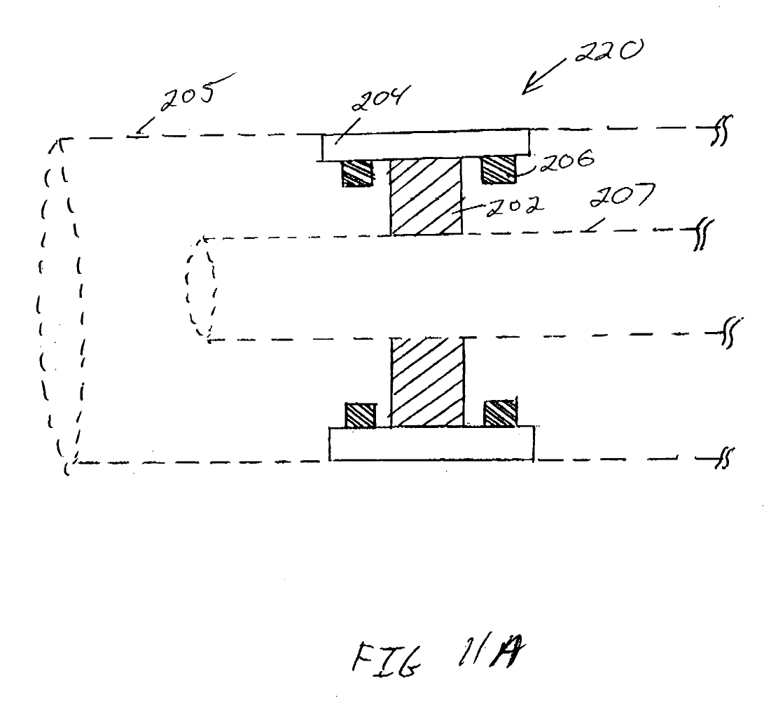

Referring to FIG. 10A, there is shown a configuration of a sealing assembly 210 in a relaxed state, while FIG. 10B shows a configuration of sealing assembly 210 in a compressed state, according to another design form.

The illustrated sealing assembly 210 likewise includes retention ring 204 and radial compression limiting means 206 similar to the like-numbered components of assembly 200 of FIG. 9, but is modified so that the associated annular seal 212 is not joined to retention ring 204 but is secured about inner cylinder 207. As shown in FIG. 10B, it is seen that sealing assembly 210 operates similarly to sealing assembly 200 of FIG. 9 in regard to the deployment and functionality of means 206 vis-à-vis limiting the radial compression of seal 212.

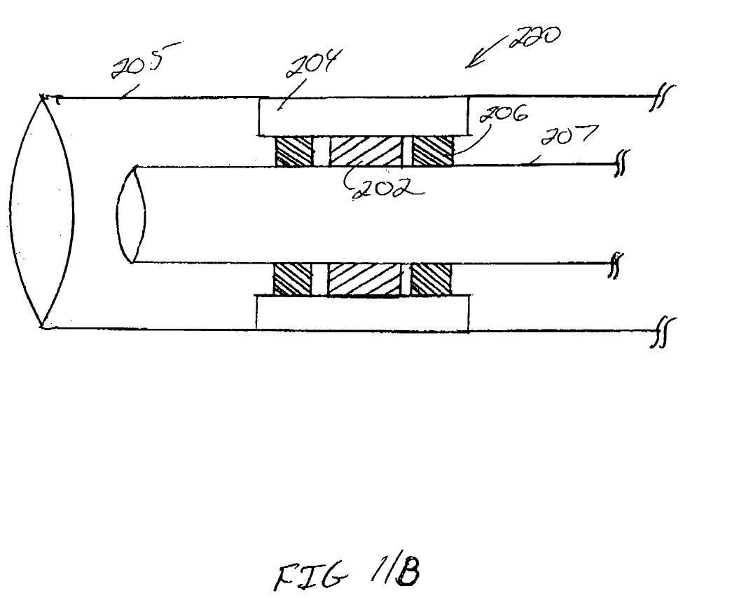

Referring to FIG. 11A, there is shown a configuration of a sealing assembly 220 in a relaxed state, while FIG. 11B shows a configuration of sealing assembly 220 in a compressed state, according to another design form.

The illustrated sealing assembly 220 is similar to sealing assembly 200 of FIG. 9 in that it likewise includes seal 202, ring 204, and compression limiting means 206 in the same cooperative relationship, except that assembly 220 is now disposed entirely within the outer cylinder 205, i.e., retention ring 204 is joined to an inner diametrical surface of outer cylinder 205. In all other respects, sealing assembly 220 operates similarly to sealing assembly 200 of FIG. 9.

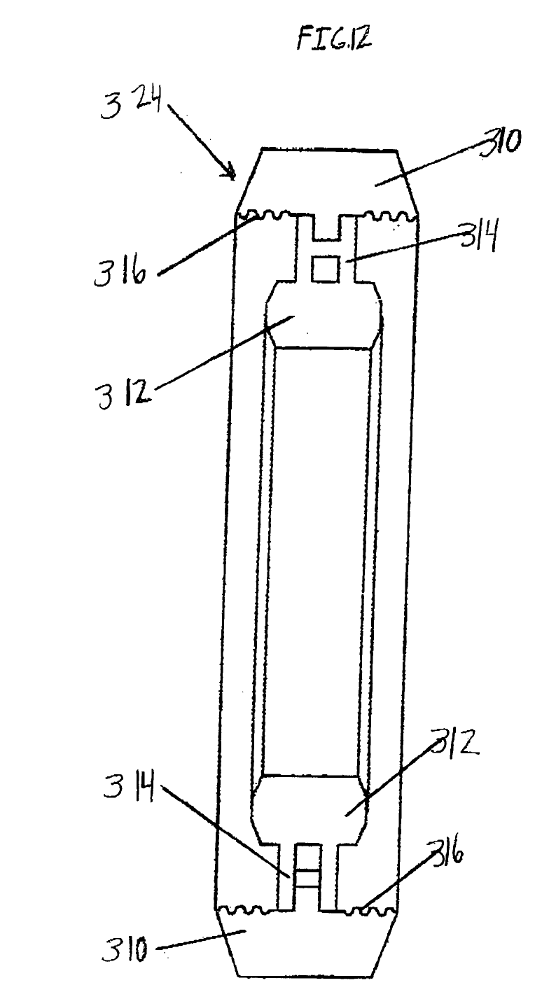

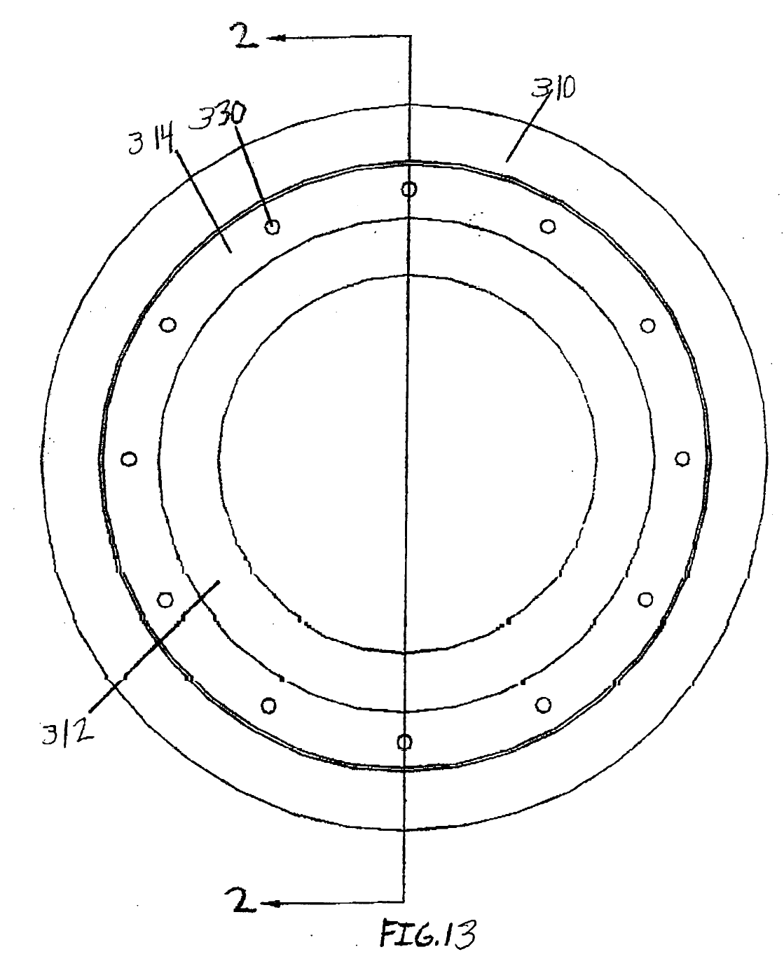

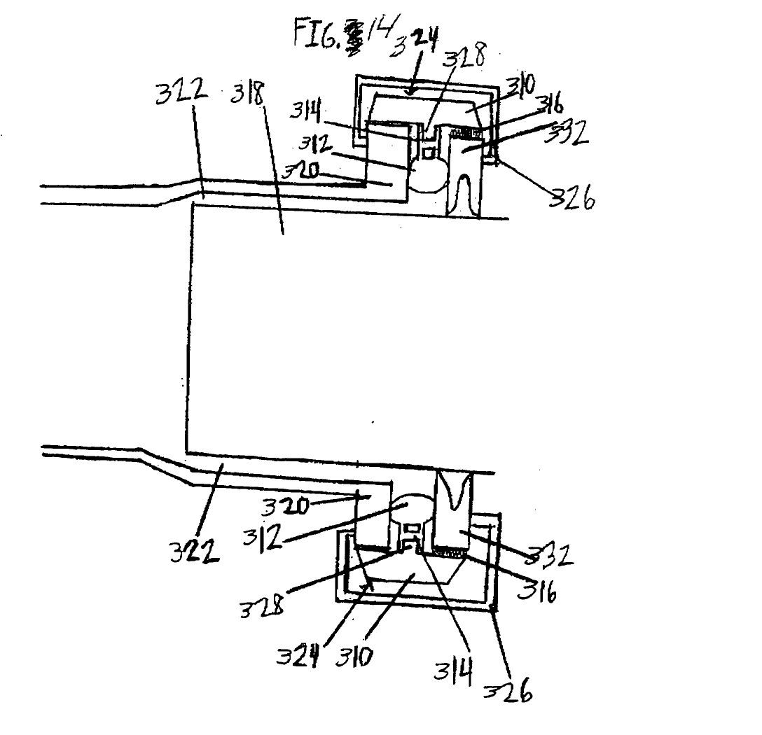

Referring now to FIGS. 12-14, there is shown a series of views depicting one particular form of the invention as variously described above, for example, in FIGS. 1-7. FIG. 14 is an axial cross-sectional view of a sealing device 324 as installed in an illustrative application environment. FIG. 13 is an axial end view of sealing device 324. FIG. 12 is an axial cross-sectional view of sealing device 324 taken along lines 2-2′ of FIG. 13.

Referring first to FIG. 14, sealing device 324 is provided to seal an opening 322 between a first member 318 and a second member 320. First member 318 and second member 320 are tubes but can be other shapes such as members with small tube-shaped components attached to a member. Other types of members can utilize sealing device 324 as well.

Sealing device 324, as shown further in FIGS. 12 and 13, has a retention ring 310. Retention ring 310 is made of plastic or metal. Retention ring 310 can be made from other materials as well.

A seal 312 is connected to retention ring 310. Seal 312 is made from an elastomeric material, such as rubber. Seal 312 is not limited to being made from an elastomeric material and other materials can be used. Also, seal 312 is connected to either the first member (tube) 318 or second member (tube) 320 with an absence of a retention groove, slot, furrow, or opening on either of first member 318 or second member 320. Furthermore, seal 312 is connected to retention ring 310 and therefore not free to move in an opening, such as a gland.

First member 318 and/or second member 320 has a flange 332. For example purposes and as shown in FIG. 14, first member 318 has flange 332. First member flange 332 is in contact with retention ring 310 when sealing device 324 is utilized with first member 318 and second member 320. First member flange 332 can have crush ribs 316 to create an interference fit with retention ring 310. Second member 320 is in contact with retention ring 310 when sealing device 324 is utilized as well. Second member 320 can also have crush ribs 316 to create an interference fit with retention ring 310.

A compression limiting means 314 is utilized to limit the compression between a first member 318, in particular first member flange 332, and second member 320 to avoid extrusion of seal 312. In one form, compression limiting means 314 is an elastomeric material surrounding a retention ring flange 328 made of metal or plastic. The elastomeric material can also fill in the interior of a hole 330 located in retention ring flange 328 (Fi. 13).

Due to the fact that retention ring flange 328 is made of a metal or a plastic (e.g., comparatively more rigid than the seal), retention ring flange 328 will limit the compression between first member flange 332 and second member 320 as the elastomeric material of compression limiting means 314 is compressed into contact with the metal or plastic of retention ring flange 328.

Therefore, once compression limiting means 314 is compressed to a predetermined amount based on the amount and type of elastomeric material, as well as, the design of retention ring flange 328, retention ring flange 328 stops the compression because the metal or plastic retention ring flange 328 does not compress very much, if at all. Retention ring flange 328 can be made of materials other than metal or plastic as well.

In another form, compression limiting means 314 is retention ring flange 328 and retention ring flange 328 is made of metal or plastic. In operation, as first member flange 332 moves toward second member 320, retention ring flange 328 will limit the compression because the metal or plastic retention ring flange 328 will not compress very much, if at all. Other types of devices may be utilized to limit compression between first member 318 and second member 320 as well.

In other forms, stop blocks and/or other devices can be added to sealing device 324 to limit compression between first member flange 332 and second member 320 to avoid extrusion of seal 312.

Seal 312 is utilized to create an axial sealing engagement with first member 318 and second member 320. Seal 312 is considered a face seal but other types of axial seals may be utilized as well. Seal 312 seals opening 322 between first member flange 332 and second member 320. Other openings between first member 318 and second member 320 can be sealed as well.

A clip 326 may be utilized to keep sealing device 324 in contact with first member flange 332 and second member 320. Devices other than clip 326 can be utilized to keep sealing device 324 in contact with first member 332 and second member 320 as well.

In operation, as fluid passes through opening 322 between first member flange 332 and second member 320, seal 312 stops the fluid from passing past first member flange 332 and second member 320. Seal 312 is considered a face seal because the axial engagement with first member flange 332 and second member 320 allows the members to move a considerable amount without breaking the sealing engagement.

Sealing device 324 is reversible so that the components of sealing device 324 cannot be assembled incorrectly. The components of sealing device 324 can be connected to one another facing in either direction; and, because they are reversible, sealing device 324 will still operate properly.

Sealing device 324 can be utilized in air conditioning lines, coolant lines, as well as, air conditioning joints. Sealing device 324 can be utilized in other devices as well.

Sealing device 324, in other alternate forms, may be considered to include a retention ring, a seal connected to the retention ring, and a compression limiting means connected to the retention ring for preventing the seal from being compressed beyond a predetermined amount.

In another form, sealing device 324 may be considered to include a retention ring in contact with a first member and a second member; a seal connected to the retention ring, where the seal is disposed in axial sealing engagement with the first member and the second member; and a compression limiting means connected to the retention ring for preventing the seal from being compressed beyond a predetermined amount. The retention ring may include crush ribs. Additionally, at least one of the first member and the second member creates an interference fit with the crush ribs.

In another form, sealing device 324 may be considered to include a retention ring in contact with a first tube and a second tube, and a seal connected to the retention ring. The seal is disposed in axial sealing engagement with the first tube and the second tube with an absence of a retention groove on either of the first tube or the second tube. A compression limiting means is connected to the retention ring for preventing the seal from being compressed beyond a predetermined amount.

The retention ring, in alternate forms, may be of plastic and/or metal. The seal and compression limiting means may be made of an elastomeric material. Additionally, the seal may be considered a face seal. Moreover, the apparatus can be constructed to be reversible.

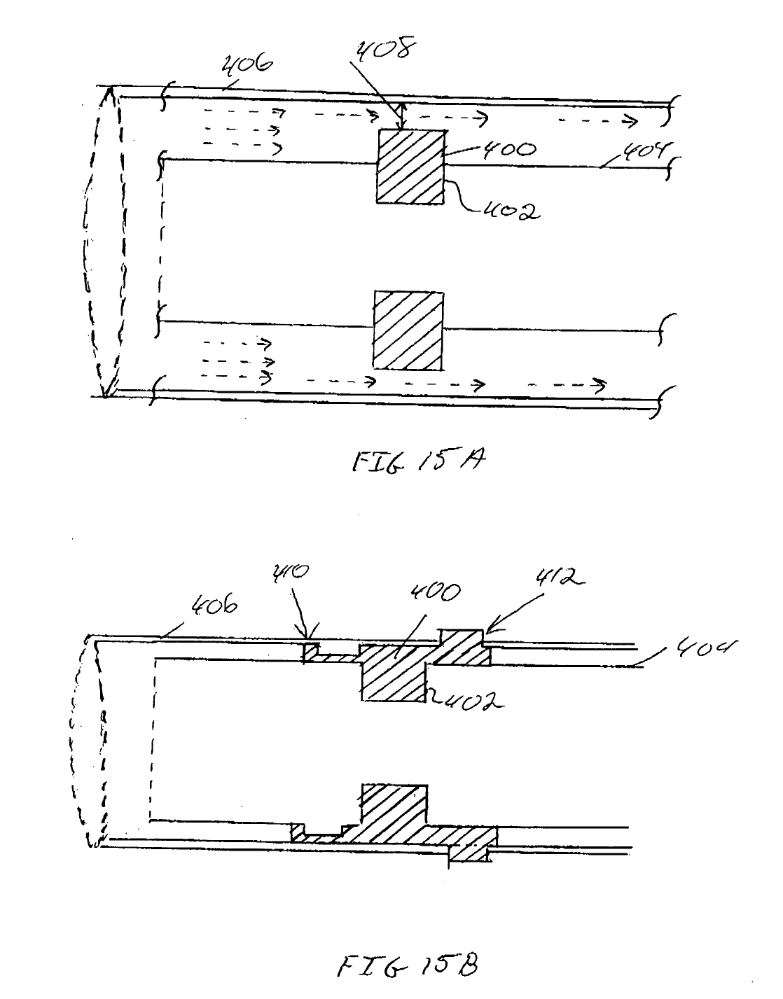

By way of background, FIG. 15A and FIG. 15B depict axial cross-sectional views of a conventional sealing arrangement in which a seal 400 disposed in a channel groove 402 machined into cylinder 404 provides radial sealing between inner cylinder 404 and outer cylinder 406 to prevent the flow of fluid through clearance 408. FIG. 15B, in particular, shows areas where over-compression of seal 400 has resulted in the extrusion activity generally depicted at 410 and 412. The invention, as described above, overcomes the problems evident in FIG. 15, specifically in regard to the extrusion and the use of a machined groove.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An assembly for operable use with a first member and a second member, said assembly comprising:
a seal, said seal having at least one axial sealing face for operable engagement with at least one of the first member and the second member; and
a retainer ring, said retainer ring carrying said seal.

2. The assembly as recited in claim 1, wherein the positional relationship of said seal relative to the first member and/or the second member being operably established and/or maintained without positive retention and/or registration by the first member and the second member.

3. The assembly as recited in claim 1, wherein operative positional placement of said seal relative to the first member and/or the second member occurring without retention and/or registration by the first member and the second member.

4. The assembly as recited in claim 1, wherein said seal being positionable with respect to the first member and/or the second-member independently of any seal-type retention and/or registration by the first member and the second member.

5. The assembly as recited in claim 1, wherein said retainer ring being operably annularly disposed about the first member and/or the second member.

6. The assembly as recited in claim 1, wherein said retainer ring being operably coupled to the first member and/or the second member.

7. The assembly as recited in claim 1, wherein said retainer ring having an interference fit coupling with the first member and/or the second member.

8. The assembly as recited in claim 1, wherein said retainer ring having a material composition including plastic and/or metal.

9. The assembly as recited in claim 1, wherein the first member and the second member in operable telescoping relationship to one another, at least in part.

10. The assembly as recited in claim 9, wherein said seal being operably disposed between an annular radial flange of the first member and an opposing annular radial flange of the second member.

11. The assembly as recited in claim 1, wherein the first member and the second member in operable end-to-end relationship to one another.

12. The assembly as recited in claim 11, wherein said seal being operably disposed between a terminal end face of the first member and an opposing terminal end face of the second member.

13. The assembly as recited in claim 1, wherein said seal having a material composition including elastomer.

14. The assembly as recited in claim 1, further includes:
a first element joined to and disposed annularly between said retainer ring and said seal.

15. The assembly as recited in claim 14, wherein said first element defining a limit on axial compression of said seal.

16. The assembly as recited in claim 14, wherein said seal extending radially along said first element.

17. The assembly as recited in claim 14, wherein said first element having a rigidity greater than a rigidity of said seal.

18. The assembly as recited in claim 14, wherein said first element having an axial extent less than an axial extent of said seal.

19. The assembly as recited in claim 14, wherein said first element constituting a part of said retainer ring and defining a flange extending radially therefrom.

20. The assembly as recited in claim 19, further includes:
a second element joined to and disposed annularly between said seal and the radial flange of said retainer ring.

21. The assembly as recited in claim 20, wherein said seal and said second element each including an elastomer.

22. The assembly as recited in claim 20, wherein said second element constituting a part of said seal.

23. The assembly as recited in claim 20, wherein said second element extending radially along the radial flange of said retainer ring.

24. The assembly as recited in claim 1, further includes:
means for opposing axial compression of said seal beyond a predetermined measure.

25. The assembly as recited in claim 1, further includes:
means for fixing a limit on compression of said seal in at least one axial direction.

26. An assembly for operable use with a first member and a second member, said assembly comprising:
a seal, said seal being operably configured to provide axial sealing with respect to at least one of the first member and the second member; and
a retainer ring, said retainer ring carrying said seal.

27. The assembly as recited in claim 26, wherein the positional relationship of said seal relative to the first member and/or the second member being operably established and/or maintained without positive retention and/or registration by the first member and the second member.

28. The assembly as recited in claim 26, wherein said retainer ring being operably coupled to the first member and/or the second member.

29. The assembly as recited in claim 26, further includes:
a first element joined to and disposed annularly between said retainer ring and said seal.

30. The assembly as recited in claim 29, wherein said seal extending radially along said first element.

31. The assembly as recited in claim 29, wherein said first element constituting a part of said retainer ring and defining a flange extending radially therefrom.

32. The assembly as recited in claim 26, further includes:
means for opposing axial compression of said seal beyond a predetermined measure.

33. The assembly as recited in claim 26, further includes:
means for fixing a limit on compression of said seal in at least one axial direction.

34. An assembly for operable use with a first member and a second member, said assembly comprising:
first means for providing axial sealing engagement with the first member and/or the second member; and
second means for carrying said first means.

35. The assembly as recited in claim 34, wherein the carriage function provided by said second means being performed independently of the first member and the second member.

36. The assembly as recited in claim 34, wherein said first means includes a seal.

37. The assembly as recited in claim 36, further includes:
third means for defining a limit on axial compression of said seal.

38. The assembly as recited in claim 37, wherein said third means constituting a part of said second means.

39. The assembly as recited in claim 38, wherein said second means includes a retainer ring, and said third means includes a flange extending radially from an inner periphery of said retainer ring.

40. An assembly for operable use with a first member and a second member, said assembly comprising:
a retainer ring; and
a seal carried by said retainer ring, said seal being operably disposed in sealing relationship to the first member and the second member independently of positive retention and/or registration by the first member and the second member.

41. The assembly as recited in claim 40, wherein said seal being operably disposed in axial sealing relationship to the first member and the second member.

42. The assembly as recited in claim 40, further includes:
a first element joined to and disposed annularly between said retainer ring and said seal.

43. The assembly as recited in claim 42, wherein said seal extending radially along said first element.

44. The assembly as recited in claim 42, wherein said first element constituting a part of said retainer ring and defining a flange extending radially therefrom.

45. The assembly as recited in claim 40, further includes:
means for fixing a limit on compression of said seal in at least one axial direction.

46. An assembly, comprising:
a seal; and
a stop device coupled to said seal, said stop device being configured to define a limit on operative compression of said seal in at least one axial direction.

47. The assembly as recited in claim 46, wherein said stop device further includes:
a first element joined to and disposed annularly about said seal.

48. The assembly as recited in claim 46, further includes:
a retainer ring carrying said seal.

49. The assembly as recited in claim 48, wherein said stop device further includes:
an annular flange, said flange extending radially from an inner surface of said retainer ring.

50. An apparatus, comprising:
a seal;
a retainer ring, said retainer ring carrying said seal; and
a flange unit, said flange unit being joined to and disposed annularly between said seal and said retainer ring.

51. The apparatus as recited in claim 50, wherein the flange unit forming part of said retainer ring.

52. The apparatus as recited in claim 50, wherein the flange unit having a rigidity greater than a rigidity of said seal.

53. The apparatus as recited in claim 50, wherein said seal extending radially along said flange unit.

54. The apparatus as recited in claim 50, wherein said flange unit having an axial extent less than an axial extent of said seal.
